(19) United States
(12) Patent Application Publication
(10) Pub. No.: US 2013/0138533 A1
(43) Pub. Date: May 30, 2013

(54) APPARATUS AND METHOD FOR ENSURING THE QUALITY AND PRICE OF A GOOD SOLD ONLINE

(71) Applicants: Harry Vartanian, Philadelphia, PA (US); Jaron Jurikson-Rhodes, Philadelphia, PA (US)

(72) Inventors: Harry Vartanian, Philadelphia, PA (US); Jaron Jurikson-Rhodes, Philadelphia, PA (US)

(73) Assignee: HJ LABORATORIES, LLC, Philadelphia, PA (US)

(21) Appl. No.: 13/307,848

(22) Filed: Nov. 30, 2011

(51) Int. Cl. G06Q 30/06

(52) U.S. Cl. 705/26.35

(57) ABSTRACT

An apparatus and method for ensuring the quality and price of a good sold online is disclosed. In return for a small fee or purchase add-on, the quality or price of a good may be guaranteed by the online store or a third party. The small fee or purchase add-on amount is determined based on in part by a quality metric or a calculated return risk by a computer. If the buyer is not satisfied with a good purchased online, free return shipping, or some other incentive may be provided by the apparatus.

### FIELD OF INVENTION

This application is related to an apparatus and method for ensuring the quality and price of a good sold online.

### BACKGROUND

Online commerce or shopping is growing at a rapid pace and gaining more market share from brick and mortar stores annually. While growing in popularity, brick and mortar stores have significant competitive advantages over e-tailors, online retailers, online stores, or online warehouses. Some advantages include superior product representation, better quality determination, immediate receipt of goods, and quick return of goods. On the contrary, advantages of online shopping include greater selection, lower prices, more comprehensive product research information, customer reviews, no travel costs, and no travel time.

Online quality determination may be easy when a product on a given site is reviewed by many customers and these reviews are archived on a computer for retrieval by a potential buyer. However, customer reviews from one site may not provide enough of a comprehensive review of a product. Moreover, the number of reviews for some products are low making them an unreliable metric. Manually using a search engine to determine product quality based on customer comments on blogs or other sites is very time consuming. Beyond customer reviews and ratings, there is no standardized, quick, or simple way to compare the quality of a product to others in the same brand or among different brands.

Online comparison shopping can be superior to brick and mortar commerce. However, it can be time consuming manually finding the lowest price and shipping for a given product by visiting multiple sites on different servers on the Internet.

With respect to returns, many merchants online have attempted to make returns easy. However, in many cases return shipping and restocking fees may be paid for by the buyer. Paying return shipping and restocking fees may sometimes make up the difference in a lower price offered by an online retailer versus a brick and mortar store.

It is desirable to provide an apparatus and method for determining the quality of a good. It is also desirable to provide an apparatus and method for ensuring the quality and price of a good sold online for better online commerce and business.

### SUMMARY

An apparatus and method for ensuring the quality and price of a good sold online is disclosed. In return for a small fee or purchase add-on, the quality or price of a good may be guaranteed by the online store or a third party. The small fee or purchase add-on amount is determined based on in part by a quality metric or a calculated return risk by a computer. If the buyer is not satisfied with a good purchased online, free return shipping, or some other incentive may be provided by the apparatus.

### BRIEF DESCRIPTION OF THE DRAWINGS

A more detailed understanding may be had from the following description, given by way of example in conjunction with the accompanying drawings wherein:

FIG. 1 is a diagram of an object device;

FIG. 2 is an apparatus for ensuring the quality and price of a good sold online; and

FIG. 3 is a process for offering an easy return shipping program by a computer.

### DETAILED DESCRIPTION

The present embodiments will be described with reference to the drawing figures wherein like numerals represent like elements throughout. For the methods and processes described below the steps recited may be performed out of sequence in any order and sub-steps not explicitly described or shown may be performed. In addition, “coupled” or “operatively coupled” may mean that objects are linked between zero or more intermediate objects. Also, any combination of the disclosed features/elements may be used in one or more embodiments. When referring to “A or B”, it may include A, B, or A and B, which may be extended similarly to longer lists.

In the examples forthcoming, a customer, consumer, shopper, buyer, or user is provided the option of purchasing easy or no questions asked return shipping for a certain low price by an online store or merchant running on one or more servers. The certain low price is determined based on a quality metric related to the good. The good may be new, used, or refurbished. Put another way, the certain low price provides microinsurance for a purchase that insures against loss of return shipping or other costs incurred with a return. Although the examples given below are within the context of online shopping the quality metric may also apply to telesales and certain brick and mortar sales. For instance, a user may use a mobile application and camera to search for a quality metric related to a good found in a store by a taking a photo of the good.

The low price for the easy or no questions asked return shipping may be calculated or determined, for example, based on one or more attributes that may include aggregate customer reviews of the good, the price of the good, the weight of the good, speed of shipping, shipping location, return history, the brand name of the good, aggregate customer reviews of the brand, or awards given to the brand. Moreover, any other customer habits or preferences may be analyzed to determine a return shipping price. These data points and others described below may be used to calculate a return risk or quality metric by a computer, client device, or server to determine the low price return. The return risk or quality metric may also be used by the computer, client device, or server to determine the guaranteed price of the good.

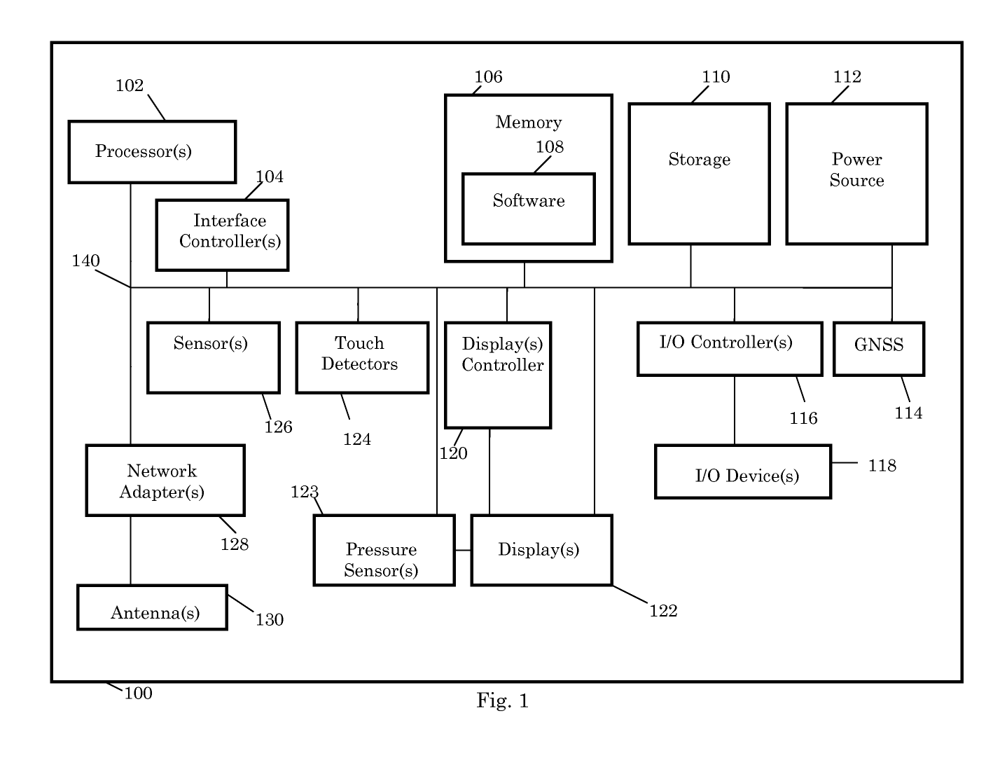

FIG. 1 is a diagram of an object device 100 that may be configured as a server, computer, client device, cloud server, part of a cloud based machine, an application service provider machine, wireless subscriber unit, user equipment (UE), mobile station, smartphone, mobile computer, cellular telephone, telephone, personal digital assistant (PDA), computing device, surface computer, tablet computer, monitor, general display, versatile device, appliance, automobile computer system, vehicle computer system, part of a windshield computer system, television device, home appliance, home computer system, laptop, netbook, tablet computer, personal computer (PC), an Internet pad, digital music player, media player, video game device, augmented reality device, a component of another device, or any electronic device for mobile or fixed applications.

Object device 100 comprises computer bus 140 that couples one or more processors 102, one or more interface controllers 104, memory 106 having software 108, storage device 110, power source 112, and/or one or more displays controller 120. Object device 100 includes one or more display devices 122.

One or more display devices 122 can be configured as a plasma, liquid crystal display (LCD), light emitting diode (LED), field emission display (FED), surface-conduction electron-emitter display (SED), organic light emitting diode (OLED), or flexible OLED display device. The one or more display devices 122 may be configured, manufactured, produced, or assembled based on the descriptions provided in U.S. Patent Publication Nos. 2007-247422, 2007-139391, 2007-085838, 2006-096392, or 2010-295812 or U.S. Pat. No. 7,050,835 all herein incorporated by reference as if fully set forth. In the case of a flexible or bendable display device, the one or more electronic display devices 122 may be configured and assembled using organic light emitting diodes (OLED), liquid crystal displays using flexible substrate technology, flexible transistors, field emission displays (FED) using flexible substrate technology, or the like.

One or more display devices 122 can be configured as a touch, multi-touch, multiple touch, or swipe screen display using resistive, capacitive, surface-acoustic wave (SAW) capacitive, infrared, strain gauge, optical imaging, dispersive signal technology, acoustic pulse recognition, frustrated total internal reflection, magneto-strictive technology, or the like. One or more display devices 122 can also be configured as a three dimensional (3D), electronic paper (e-paper), or electronic ink (e-ink) display device.

Coupled to one or more display devices 122 may be pressure sensors 123. Coupled to computer bus 140 are one or more input/output (I/O) controller 116, I/O devices 118, global navigation satellite system (GNSS) device 114, one or more network adapters 128, and one or more antennas 130. Examples of I/O devices include a speaker, microphone, keyboard, keypad, touchpad, display, touchscreen, wireless gesture device, a digital camera, a digital video recorder, a vibration device, universal serial bus (USB) connection, a USB device, or the like. An example of GNSS is the Global Positioning System (GPS). Object device 100 may be configured such that a reserved battery source in power source 112 is used for GNSS device 114.

Object device 100 may have one or more motion, movement, rotation, gyration, vibration, zoom, proximity, light, infrared, optical, chemical, biological, vital signs, environmental, moisture, acoustic, heat, temperature, humidity, barometric pressure, radio frequency identification (RFID), biometric, biometric feedback, pulse, brainwaves, face recognition, text recognition, image recognition, graphics recognition, photo recognition, video recognition, speech recognition, audio recognition, music recognition, and/or voice recognition sensors 126. One or more sensors 126 may be configured as a digital camera, infrared camera, accelerometer, multi-axis accelerometer, an electronic compass (e-compass), gyroscope, multi-axis gyroscope, a 3D gyroscope, or the like.

Object device comprises touch detectors 124 for detecting any touch inputs, including multi-touch inputs and swipe inputs, for one or more display devices 122. One or more interface controllers 104 may communicate with touch detectors 124 and I/O controller 116 for determining user inputs to object device 100. Coupled to one or more display devices 122 may be pressure sensors 123 for detecting presses on one or more display devices 122.

Still referring to object device 100, storage device 110 may be any disk based or solid state memory device for storing data. Power source 112 may be a plug-in, battery, fuel cells, solar panels for receiving and storing solar energy, or a device for receiving and storing wireless power as described in U.S. Pat. No. 7,027,311 herein incorporated by reference as if fully set forth. Power source 112 may be one or more batteries such as nickel-cadmium (NiCd), nickel-zinc (NiZn), nickel metal hydride (NiMH), lithium-ion (Li-ion), or the like.

One or more network adapters 128 may be configured as an Ethernet, 802.x, fiber optic, Frequency Division Multiple Access (FDMA), single carrier FDMA (SC-FDMA), Time Division Multiple Access (TDMA), Code Division Multiple Access (CDMA), Orthogonal Frequency-Division Multiplexing (OFDM), Orthogonal Frequency-Division Multiple Access (OFDMA), Global System for Mobile (GSM) communications, Interim Standard 95 (IS-95), IS-856, Enhanced Data rates for GSM Evolution (EDGE), General Packet Radio Service (GPRS), Universal Mobile Telecommunications System (UMTS), cdma2000, wideband CDMA (W-CDMA), High-Speed Downlink Packet Access (HSDPA), High-Speed Uplink Packet Access (HSUPA), High-Speed Packet Access (HSPA), Evolved HSPA (HSPA+), Long Term Evolution (LTE), LTE Advanced (LTE-A), 802.11x, Wi-Fi, Zigbee, Ultra-WideBand (UWB), 802.16x, 802.15, Wi-Max, mobile Wi-Max, Bluetooth, radio frequency identification (RFID), Infrared Data Association (IrDA), near-field communications (NFC), or any other wireless or wired transceiver for modulating and demodulating signals via one or more antennas 130. One or more network adapters 128 may also be configured for automobile to automobile, car to car, vehicle to vehicle (V2V), or wireless access for vehicular environments (WAVE) communication.

For certain configurations, such as a server, selective components are provided from object device 100 to be configured as a server. Moreover, object device 100 may specifically be configured to operate for any of the examples forthcoming for apparatuses and processes. Any of devices, controllers, displays, components, etc. in object device 100 may be combined, made integral, removed, or separated as desired.

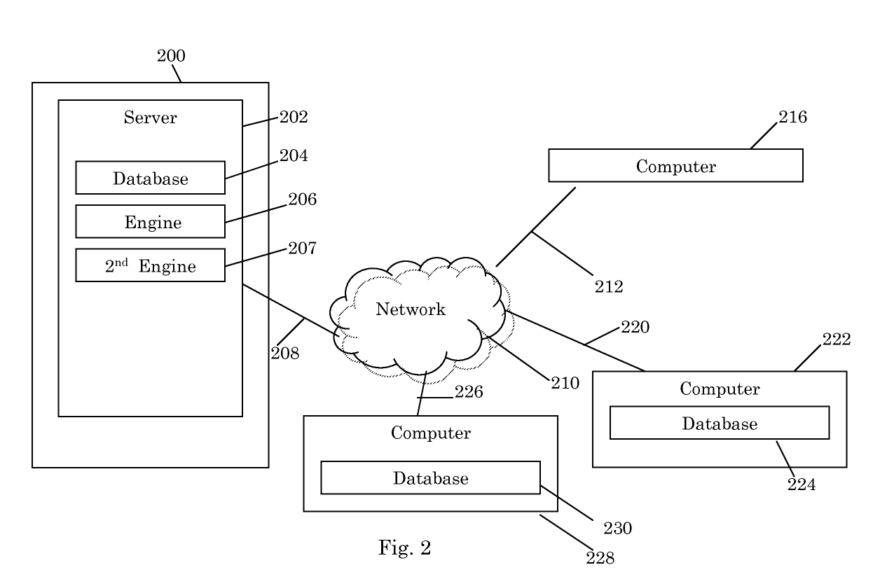

FIG. 2 is an apparatus 200 for ensuring the quality and price of a good sold online. Apparatus 200 may have some parts or components of object device 100 including one or more processors 102 and memory 106. Apparatus 200 may be partly configured as a server, computer, client device, part of a cloud based machine, an application service provider (ASP) machine, or the like. Apparatus 200 includes server 202. Parts of server 202 may operate in memory 106 and reside in storage device 110. In addition to apparatus 200, other parts of server 202 may be configured to operate on other computers (not shown) to ensure the quality and price of a good sold online.

Database 204 may hold part of a diverse set of information to determine a return risk or quality metric used to provide mini-insurance, microinsurance, an easy return promise program, return assurance, or return insurance on a good, item, or product. In addition, for the examples given below, an unused service, such as an airline flight or massage, may also be considered a product.

Database 204 may be a Microsoft Access, Oracle, SQL, a relational database, or any other software structure for logically storing and organizing information. A certain good, sold by a store hosted in part on server 202, may have a predetermined or dynamic set of attributes. As previously mentioned, attributes may include aggregate customer reviews of the good, the price of the good, the weight of the good, speed of shipping, shipping location, return history, the brand name of the good, aggregate customer reviews of the brand, or awards given to the brand. Other attributes may be the average price of the good, the price variance of a good, the used value of a good, where the good is made, where parts of the good are made, types of materials used to make the good, the shape of the good, the category of the good, cost of making the good, safety, or environmental impact of the good. Any of the attributes above may be combined in different combinations and processed by a computer to provide statistically significant intelligence about the return risk or quality metric of a good.

With respect to the aggregate customer reviews attribute, a web crawler, robot, bot, or spider engine 206 on server 202 may crawl or search sites such as Google, Amazon, Yelp, CitySearch, Yahoo, blogs, message boards, etc. to accumulate or track reviews, comments, feedback, or star ratings given to a good. A web crawler, robot, bot, or spider is a computer program that browses the World Wide Web (WWW) in a methodical, automated, intelligent, or orderly manner to retrieve relevant or unique information. An example of a web crawler engine is provided in U.S. Pat. No. 7,991,762, herein incorporated by reference as if fully set forth. Any customer or user review, comment, or feedback information retrieved by a web crawler, robot, bot, or spider engine 206 on server 202 may be stored in database 204 and given a weight or score based on relevance.

With respect to customer reviews, comments, or feedback attributes related to a product, an artificial neural network or intelligence engine running in part on server 202 may be used to determine the relevance or the degree of positivity or negativity made about a product or good in comments or text on a crawled site. Examples of artificial neural networks that may be used for intelligent understanding of customer comments is provided in U.S. Publication No. 2007-094172 or U.S. Pat. No. 7,809,601 herein incorporated by reference as if fully set forth. Customer reviews, comments, or feedback scores may be weighted based on the online or offline reputation of the customer. Customer star ratings may also be weighted based on the online or offline reputation of the customer. The online or offline reputation may be determined by retrieving social networking or virtual world, such as SecondLife, information by server 202 over network 210 from another computer or user device (not shown). For instance, if it is determined that a customer has an electrical engineering degree based on information retrieved from a social networking profile by server 202, a review or rating on a flat panel television may be given a higher weighting than a review by a customer with a non-engineering degree.

If a customer review is not available or found, 2^{nd} engine 207 is a software component configured to receive request messages to demand research of an object, product, good, or item for sale. The request message may be sent over network 210 via wired or wireless communication links 208 and 212 to computer 216. A worker at a research center, on-shore or off-shore, using computer 216 manually or qualitatively determines the quality of a good specified in the request message sent by server 202. The research center may be independent so that the good is reviewed objectively. The research may be done by a specially trained individual, expert, or a team. The research conducted may be performed by searching the web or specialized private databases for relevant information relating to a product or good. This may be more desirable, effective, and efficient than a customer doing such research since the research agent is more experienced than a typical consumer and the information found may be reused later for determining an easy return shipping price for another consumer.

Any summary of a quality of a good may be verified by a supervisor or oversight committee. Moreover, the agent may test a product based on the function, style, initial build quality, and expected dependability based on historical information for a brand. The survey or analysis of the product may be qualitative or quantitative.

Moreover, the on-demand research may also be done by computer 216 initiating a crowd sourcing campaign. Crowdsourcing is a system for sourcing tasks traditionally performed by specific individuals to a group of people or community, also known as a crowd, through an open call or request. Crowdsourced review of a product may be given a higher weight than a review by a research center expert, or vice versa, based on the category of the product. In return for the review, rewards or payment of different levels may be provided to crowd members.

Alternatively, a microtasking campaign may be initiated by computer 216. Microtasking, such as Amazon's Mechanical Turk, is a process where a large task is divided into smaller tasks. Each smaller task may be completed by a different individual, such as a consumer. For example for a television, one individual may research or test the quality of the picture and return comment or opinion messages to server 202 via a fixed or mobile computer (not shown) over network 210. Another individual may research or test the quality of the sound for the television and return comment or opinion messages to server 202 via a fixed or mobile computer (not shown) over network 210. Alternatively, comments or opinions may be provided to server 202 via computer 216 over network 210.

After conducting the on-demand research or study, a quality metric attribute, such as a star rating, may be provided and sent over network 210 to server 202 and stored in database 204. The on-demand, just in time research may also provide a special certification, exclusive, or preferred label for the product to increase buyer confidence in the good if it given a high score. The preferred label may be used to classify the object such as green, luxury, fun, no-frills, good value, or any other class that distinguishes or categorizes the good from other goods.

Moreover, web crawler, robot, bot, or spider engine 206 on server 202 may crawl or search sites such as Google, Craigslist, Amazon, Best Buy, Walmart, Target, MySimon, etc. to procure price and cost attribute information. This price information may be stored in database 204 and updated weekly, daily, or hourly. This information may be used in part by server 202 to determine or calculate the average price of the good, the price variance of a good, or the used value of a good.

With respect to the brand name of the good or aggregate customer reviews of the brand attributes, server 202 may access third party database 224 on computer 222 over network 210 via wired or wireless communication links 208 and 220. Third party database 224 may have information and metrics relating to the quality or reputation of the brand name of a good or for a category of goods. The information may include historical data for one or more years prior to the inquiry by server 202. The information may also include information relating to the level of goods within a brand. For example, clothes made under the Calvin Klein or CK brand have varying qualities within the brand depending on the label, line, or design. An example of a third party database may be one maintained by Consumer Reports, FTC, better business bureau (BBB), etc.

With respect to the weight of the good, the types of materials used to make the good, or the shape of the good attributes, server 202 may access third party database 230 on computer 228 over network 210 via wired or wireless communication links 208 and 226 to retrieve metrics or statistics relating to the attributes. As an example, a higher weight of a good may represent higher quality or desirability for a piece of jewelry. As another example, a lower weight of a good may represent higher quality or desirability for an electronic good. The types of materials used to make a good may be used to determine quality by scoring in combination with the category of a good. For instance, a cashmere sweater may be of higher quality than a cotton sweater in the sweater category.

With respect to where the good is made and where parts of the good are made attributes, server 202 may retrieve this information from manufacturing sites or a third party site, such as iSuppli, and compare it to quality metrics for goods made in certain countries tabulated and stored in database 204. For instance, a suit made in Italy may be valued higher than a suit made in China. As another example, an LCD panel made in Taiwan in a television may be higher quality than an LCD panel made in China.

With respect to the speed of shipping, shipping location, or return history attributes, server 202 may track this attribute based on an online store hosted on server 220. In addition, server 202 may retrieve this information from various online stores such as Amazon, Walmart, Target, etc. Speed of shipping and shipping location is needed in order for server 202 to determine potential return shipping costs.

Moreover, the shipping location may provide insight into a return pattern for a product. For instance, a low power snow blower shipped to a customer in Green Bay, Wis. may be returned more often than one shipped to Charleston, S.C. This may be due to the fact that the snow accumulation during a typical storm in Green Bay may be much more than that in Charleston requiring a more powerful snow blower.

Return history is an attribute that provides insight into the probability of an item being returned. Poorer quality items will be returned more often than higher quality ones. In addition, this attribute may be analyzed by server 202 with other metrics to infer better intelligence about a good. For instance, the snow blower in the example given above may still be high quality for the consumer in Charleston although it was not correct product for the consumer in Green Bay.

With respect to the category of the good, server 202 may determine that certain categories of goods are returned more often than others. In addition, server 202 may determine that certain customers may return a category of goods or goods in general more often based on information in database 204. This attribute provides good intelligence about the shopping habits of a specific customer. For instance, customer A buys and returns shoes more often than other similar customers in the same age, size, height, weight, location, and education groups. As another example, customer A returns all categories of goods more often when compared to consumers with a similar profile to customer A. For this case, customer A may be classified by server 202 as a high risk returner and offered a higher return premium, or possibly no return shipping insurance at all, for a purchase.

In addition to return history, the credit score, rating, or history of a customer may be used by server 202 to determine the probability of a return. For instance, customers with higher credit scores may be more responsible and less likely to make a bad purchase.

Safety is another attribute of a good server 202 may determine. Safety information may be retrieved by server 202 over network 210 from government organizations such as the Federal Trade Commission (FTC). Moreover, safety information may be obtained by server 202 over network 210 from private or independent laboratories such as Underwriters Laboratories (UL).

With respect to environmental impact of a good, server 202 may retrieve carbon footprint information, toxic materials used to make the good, carcinogens in the good, or any other information from the environmental protection agency or a similar group over network 210 to determine the quality of a good within the context of environmental friendliness. This information may be combined with other factors about a customer to determine the probability of a return. For instance, server 202 may determine from a purchase history of a customer that he or she purchases mostly “green” products and thus is more likely to keep an environmentally friendly good.

Moreover, the bill of materials information retrieved by server 202 can be used to determine types of materials used to make the good. For instance, iSuppli.com provides information on components and chips used to build a smartphone, tablet, and other consumer electronics items. Usually, if the cost of the bill of materials is higher for a product compared to its peers, it will be of higher quality. As well as costs, brands of components used within a consumer electronics device can be analyzed by server 202 to determine the quality of a product.

In addition, database 204 may include social networking information such as a facebook like or dislike attribute retrieved by server 202 over network 210. Similar to the examples given above for customer reviews, artificial neural networks may be used for intelligent understanding of social networking comments by customers about the quality of a good.

Moreover, the return risk metric may depend upon the cost of refurbishing a returned good, return processing and handling, and repackaging cost attributes determined by server 202. These attributes may be small or large depending on a product. For instance, a returned jewelry item may have little costs in refurbishing and repackaging. On the contrary, a stereo system may have large refurbishing and repacking costs.

Using selective attributes given above, the total quality score for a good, item, or product may be determined, for example, by server 202 based on in part equation 1:

$$S ( x , t ) = {\sum }_{i = 1}^{n} {w}_{i} ( x , t ) * {A}_{i} ( x ) \qquad Equation 1$$

where the total quality score S is a function of variables x and time t. Variable x may represent a particular product or a product category. For a total quality score that is tracked monthly, t may vary from 1 to 31. For a total quality score that varies within a year, t may vary from 1 to 365. For a total quality score that varies yearly, t may vary from 1 to any positive integer k. Index i may be a variable for up to n different quality related attributes. Function w may be a proprietary weighting function that is time t and product or product category x dependent. A may be a proprietary attribute function dependent on product or product category x. Functions w and A may be determined based on logic given above for respective attributes by server 202. The total quality score S may be normalized such that it ranges, for instance, from 0 to 1, 1 to 5, or 1 to 10. In the examples given herein, the total quality score S may be used to determine a return risk metric or for any other system or process where a statistically significant quality or value of a good, item, or service needs to be calculated.

A return risk metric R may be calculated based on the total quality score S, a weighted sum of return related attributes, return shipping costs RS of product or product category x, and the return value RV of product or product category x:

$$R ( x , t ) = S ( x , t ) + {\sum }_{i = 1}^{n} {w}_{i} ( x , t ) * {RA}_{i} ( x ) + RS ( x ) + RV ( x ) \qquad Equation 2$$

Variables in equation 2 are similar to those of equation 1 above. Index i may be a variable for up to n different return related attributes. RA may be a proprietary return attribute function dependent on product or product category x. The return risk metric R may be normalized such that it ranges, for instance, from 0 to 1, 1 to 5, or 1 to 10. Table 1 shows an exemplary mapping between a return risk metric ranging from 0 to 1 and the corresponding return risk premium offered to a customer, such as before checkout or order confirmation.

TABLE 1

| | Return Risk |
|---|---|
| Return Risk | Premium (% of |
| Metric R | cost of good) |
| 0 | 3% |
| .25 | 2.5% |
| .50 | 2% |
| .75 | 1.5% |
| 1 | .5% |

Within the context of insurance, mini-insurance, microinsurance, or a value added add-on, the return risk metric R provides value from the peril and possibility of paying return shipping by a consumer. In addition to being offered a la carte, the premium can be used to price in the service into a frequent shoppers club such as Amazon Prime. If a customer is determined not to frequently return goods and purchases, the return premium or part of the premium may be returned in good faith.

In addition, to provide consumer friendliness and reduce consumer confusion, the return risk premium may be rounded to a whole dollar value on a scale. For example the scale at one store may be $1-$10 dollars. If the return risk premium is calculated to be $5.14 it may be rounded down or up to $5 or $6, respectively. The premium may be rounded up if the pool or fund of premiums for a good, store, or program is low.

The return risk premium of a good may vary dependent upon the pool or fund of premiums accumulated for the good or the whole program tracked in part by server 202. The premium may be returned in cash, points, or tokens to be added to purchase. A token may be an add on to a purchase. For instance, the buyer may request an item to be electronically blessed by a rabbi, priest, or pastor before shipping. As an example, this may be desirable for a set of knives or ladder where the risk of harm to a consumer is higher than with other goods. The return risk premium may also depend upon the claims made for a good or for the whole program in a certain time period. In most cases, a provider of easy return shipping wins with happier customers. However, in other cases the provider may want to make some profit from the program.

Certain attributes used to calculate the return risk premium by server 202 may be used to guarantee a price of a good. If an online store has accurate pricing information for a good, it may be priced within 2.5%-5% of the calculated market value by server 202. Combined with the return risk premium value, an online store may be able to command higher pricing for a good in return for the value added program.

In addition, the total quality score S may be used to rank goods returned by a shopping search engine. For instance, if a user desires a television with a total quality score higher than 7 from server 202, server 202 may take the request then return a plurality of televisions with a quality score higher than 7 that are ranked from highest to lowest rank in a list. In addition to providing a relevant list, this gives the user a way to compare similar products in a category side by side based on the total quality score.

In addition, the total quality score S may be used to create a hierarchy of products grouped in categories or subcategories. The hierarchy may also be used to show alternate products in subcategories that a shopper may be interested in and has a higher total quality score S than all the goods in the current subcategory. The hierarchy may be used to show the most popular products in a certain category, group, or subcategory all being based on in part the total quality score S. The webpage displaying the hierarchy generated by server 202 may sell paid ads or advertising space on search results page related to the products.

A total quality score database that may be stored in database 204 may also be used as a revenue or profit center for an online store by offering access to the information to users for a monthly or annual fee. In addition, access to the total quality score database may be sold to a third party provider or government agency. In addition, the total quality score database may have information for collectors items, antiques, or unique goods used by an online store to guarantee a purchase.

Once the consumer receives the product, if they are dissatisfied, they may use an enclosed return label with the good provided by the online store to make an easy no questions asked return without paying return shipping. As another example, the user may follow the online store's return instructions, paying for the return shipping themselves. Subsequently, the consumer registers the return and return shipping cost via a link in the initial purchase email, and a microinsurance company reimburses the consumer's credit card.

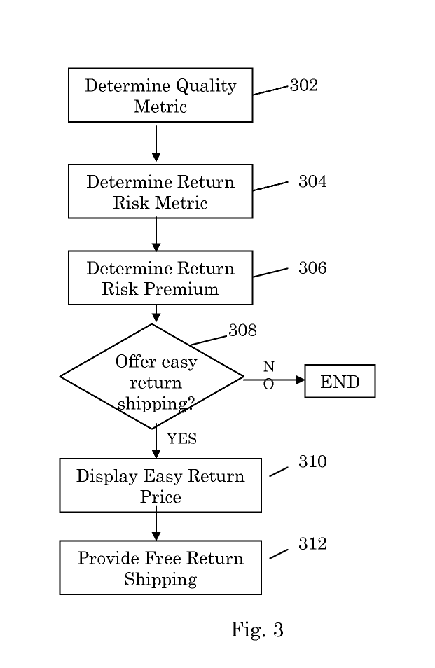

FIG. 3 is a process for offering an easy return shipping program by a computer. A quality metric, such as total quality score S, is determined in part by server 202 using selective attributes given above for a good (302). A return risk metric is determined in part by server 202 using selective attributes given above and the quality metric (304) for the good. A return risk premium is determined in part by server 202 (306) for the good. Server 202 determines whether to offer easy return shipping (308) for the good. The easy return price is displayed by server 202 based on the return risk premium (310) for the good. If a good is of very high quality, a special logo may be placed on the product's description page by server 202 as advertising. The price may be displayed before or after the good is placed in a cart, or before an order is placed. If a buyer is not subsequently satisfied with the good, free return shipping may be provided by a return order processing component on server 202 (312). The return information may be provided to the user in a standard confirmation email.

Although features and elements are described above in particular combinations, each feature or element may be used alone without the other features and elements or in various combinations with or without other features and elements. The methods, processes, or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, a subscriber identity module (SIM) card, a memory stick, a secure digital (SD) memory card, magneto-optical media, and optical media such as CD-ROM disks, digital versatile disks (DVDs), and BluRay discs.

Suitable processors include, by way of example, a general purpose processor, a multicore processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement hardware functions for use in a computer or any host computer. The programmed hardware functions may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A server comprising:
a processor, in the server, configured to access a plurality of attribute information for a product and user from a memory device;
the processor configured to dynamically calculate a quality metric for the product based on the plurality of attribute information;
the processor configured to dynamically calculate a return risk metric for the product based on the quality metric;
the processor configured to dynamically calculate a return risk premium for the product based on the return risk metric;
the processor configured to display the return risk premium for the product on a webpage hosted in part by the server;
the processor configured to process a purchase for the product and receive payment of the return risk premium; and
the processor configured to process a return of the product without requiring payment of return shipping.

2. The server of claim 1 wherein the plurality of attribute information includes a function, style, initial build quality, or expected dependability of the product.
